(19) United States
(12) Patent Application Publication
(10) Pub. No.: US 2026/0310572 A1
(43) Pub. Date: Oct. 8, 2026

(54) MANAGING THRESHOLD BENCHMARKING OF COMPUTING HARDWARE OF AN INFORMATION HANDLING SYSTEM

(71) Applicant: Dell Products L.P., Round Rock, TX (US)

(72) Inventors: Ibrahim Sayyed, Georgetown, TX (US); Laximi Lavanya Medicherla, Georgetown, TX (US); Anand Prakash Joshi, Round Rock, TX (US); Amit Kumar Tiwari, Austin, TX (US)

(21) Appl. No.: 19/173,120

(22) Filed: Apr. 8, 2025

(51) Int. Cl. G06F 11/34; G06F 11/277

(52) U.S. Cl. CPC G06F 11/3428; G06F 11/277; G06F 11/3476

(57) ABSTRACT

Managing threshold benchmarking of computing hardware of an IHS, including: monitoring computing logs of the IHS; determining, based on monitoring, whether a service event occurred at the IHS; determining that a service event occurred at the IHS, and in response: identifying a threshold benchmark associated with a computing hardware of the IHS; determining current telemetry data of the computing hardware; identifying historical telemetry data of the computing hardware; comparing the current telemetry data to the historical telemetry data; determining, based on the comparing, a delta between the current telemetry data and the historical telemetry data, and in response: updating, based on the delta, the threshold benchmark for the computing hardware; performing, at the computing hardware, a diagnostic test based on the updated threshold benchmark; determining whether the computing hardware passed the diagnostic test; determining that the computing hardware passed the diagnostic test, and in response: maintaining the updated threshold benchmark.

### BACKGROUND

### Field of the Disclosure

The disclosure relates generally to an information handling system, and in particular, managing threshold benchmarking of computing hardware of an information handling system.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes, thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

### SUMMARY

Innovative aspects of the subject matter described in this specification may be embodied in a method of managing threshold benchmarking of computing hardware of an information handling system, including monitoring computing logs of the information handling system; determining, based on monitoring the computing logs, whether a service event occurred at the information handling system; determining that a service event occurred at the information handling system, and in response: identifying a threshold benchmark associated with a computing hardware of the information handling system; determining current telemetry data of the computing hardware; identifying historical telemetry data of the computing hardware; comparing the current telemetry data to the historical telemetry data; determining, based on the comparing, a delta between the current telemetry data and the historical telemetry data, and in response: updating, based on the delta, the threshold benchmark for the computing hardware; performing, at the computing hardware, a diagnostic test based on the updated threshold benchmark; determining whether the computing hardware passed the diagnostic test; and determining that the computing hardware passed the diagnostic test, and in response: maintaining the updated threshold benchmark.

Other embodiments of these aspects include corresponding systems, apparatus, and computer programs, configured to perform the actions of the methods, encoded on computer storage devices.

These and other embodiments may each optionally include one or more of the following features. For instance, the computing logs are stored in a boot partition of a storage drive. The threshold benchmark is a base power limit (PL1). The threshold benchmark is a maximum processor clock frequency. The threshold benchmark is a battery full charge capacity (FCC). Determining, based on the comparing, that the current telemetry data is substantially the same as the historical telemetry data, and in response, maintaining the threshold benchmark. Determining that the computing hardware failed the diagnostic test, and in response: further updating the updated threshold benchmark for the computing hardware; performing, at the computing hardware, a further diagnostic test based on the further updated threshold benchmark; determining whether the computing hardware passed the further diagnostic test; and determining that the computing hardware passed the further diagnostic test, and in response: maintaining the further updated threshold benchmark.

The details of one or more embodiments of the subject matter described in this specification are set forth in the accompanying drawings and the description below. Other potential features, aspects, and advantages of the subject matter will become apparent from the description, the drawings, and the claims.

### BRIEF DESCRIPTION OF DRAWINGS

FIG. 1 is a block diagram of selected elements of an embodiment of an information handling system.

FIG. 2 illustrates a block diagram of an information handling system for managing threshold benchmarking of computing hardware.

FIG. 3 illustrates a method for managing threshold benchmarking of computing hardware.

### DESCRIPTION OF PARTICULAR EMBODIMENT(S)

This disclosure discusses methods and systems for managing threshold benchmarking of computing hardware of an information handling system. In short, the present invention discusses that to dynamically refresh threshold benchmarking after a service repair reset, the information handling system detects the reset event by monitoring specific logs. Upon detection, the information handling system reassesses and updates the threshold benchmarks. This involves collecting new data from the current state of the information handling system and performance metrics, analyzing this data against historical records, and considering any changes in the configuration or environment of the information handling system. The analysis determines if existing thresholds are still appropriate or need adjustment to ensure accurate test pass/fail results.

Based on the analysis, the information handling system updates the threshold benchmarks by setting new values, adjusting existing ones, or adding new benchmarks if necessary. These updated thresholds are then applied to maintain accurate and relevant benchmarks. The information handling system continues to monitor its performance and make further adjustments as needed, ensuring the thresholds remain effective over time.

Specifically, this disclosure discusses a system and a method for managing threshold benchmarking of computing hardware of an information handling system, including monitoring computing logs of the information handling system; determining, based on monitoring the computing logs, whether a service event occurred at the information handling system; determining that a service event occurred at the information handling system, and in response: identifying a threshold benchmark associated with a computing hardware of the information handling system; determining current telemetry data of the computing hardware; identifying historical telemetry data of the computing hardware; comparing the current telemetry data to the historical telemetry data; determining, based on the comparing, a delta between the current telemetry data and the historical telemetry data, and in response: updating, based on the delta, the threshold benchmark for the computing hardware; performing, at the computing hardware, a diagnostic test based on the updated threshold benchmark; determining whether the computing hardware passed the diagnostic test; and determining that the computing hardware passed the diagnostic test, and in response: maintaining the updated threshold benchmark.

In the following description, details are set forth by way of example to facilitate discussion of the disclosed subject matter. It should be apparent to a person of ordinary skill in the field, however, that the disclosed embodiments are exemplary and not exhaustive of all possible embodiments.

For the purposes of this disclosure, an information handling system may include an instrumentality or aggregate of instrumentalities operable to compute, classify, process, transmit, receive, retrieve, originate, switch, store, display, manifest, detect, record, reproduce, handle, or utilize various forms of information, intelligence, or data for business, scientific, control, entertainment, or other purposes. For example, an information handling system may be a personal computer, a PDA, a consumer electronic device, a network storage device, or another suitable device and may vary in size, shape, performance, functionality, and price. The information handling system may include memory, one or more processing resources such as a central processing unit (CPU) or hardware or software control logic. Additional components of the information handling system may include one or more storage devices, one or more communications ports for communicating with external devices as well as various input and output (I/O) devices, such as a keyboard, a mouse, and a video display. The information handling system may also include one or more buses operable to transmit communication between the various hardware components.

For the purposes of this disclosure, computer-readable media may include an instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory (SSD); as well as communications media such as wires, optical fibers, microwaves, radio waves, and other electromagnetic and/or optical carriers; and/or any combination of the foregoing.

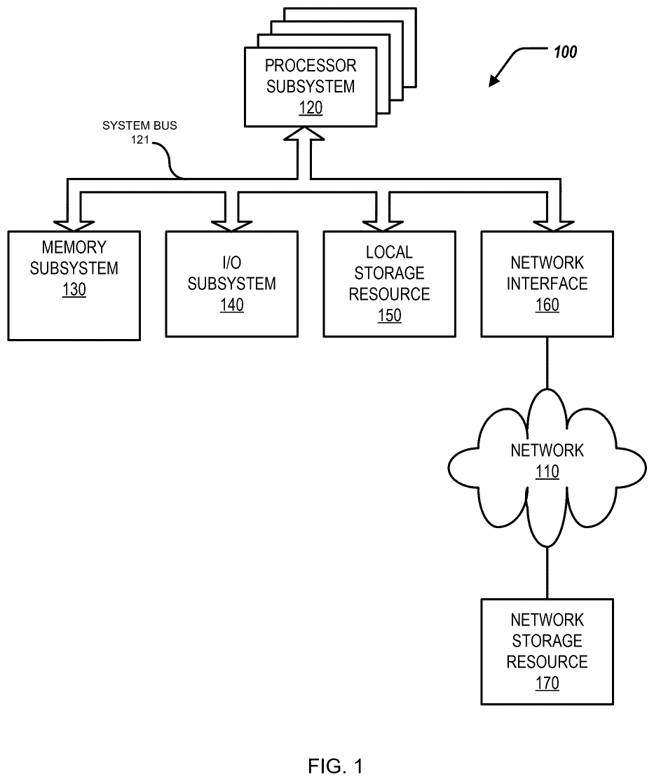

Particular embodiments are best understood by reference to FIGS. 1-3 wherein like numbers are used to indicate like and corresponding parts.

Turning now to the drawings, FIG. 1 illustrates a block diagram depicting selected elements of an information handling system 100 in accordance with some embodiments of the present disclosure. In various embodiments, information handling system 100 may represent different types of portable information handling systems, such as, display devices, head mounted displays, head mount display systems, smart phones, tablet computers, notebook computers, media players, digital cameras, 2-in-1 tablet-laptop combination computers, and wireless organizers, or other types of portable information handling systems. In one or more embodiments, information handling system 100 may also represent other types of information handling systems, including desktop computers, server systems, controllers, and microcontroller units, among other types of information handling systems. Components of information handling system 100 may include, but are not limited to, a processor subsystem 120, which may comprise one or more processors, and system bus 121 that communicatively couples various system components to processor subsystem 120 including, for example, a memory subsystem 130, an I/O subsystem 140, a local storage resource 150, and a network interface 160. System bus 121 may represent a variety of suitable types of bus structures, e.g., a memory bus, a peripheral bus, or a local bus using various bus architectures in selected embodiments. For example, such architectures may include, but are not limited to, Micro Channel Architecture (MCA) bus, Industry Standard Architecture (ISA) bus, Enhanced ISA (EISA) bus, Peripheral Component Interconnect (PCI) bus, PCI-Express bus, HyperTransport (HT) bus, and Video Electronics Standards Association (VESA) local bus.

As depicted in FIG. 1, processor subsystem 120 may comprise a system, device, or apparatus operable to interpret and/or execute program instructions and/or process data, and may include one or more processing resources such as a central processing unit (CPU), microprocessor, microcontroller, digital signal processor (DSP), application specific integrated circuit (ASIC), or another digital or analog circuitry configured to interpret and/or execute program instructions and/or process data. In some embodiments, processor subsystem 120 may interpret and/or execute program instructions and/or process data stored locally (e.g., in memory subsystem 130 and/or another component of information handling system 100). In the same or alternative embodiments, processor subsystem 120 may interpret and/or execute program instructions and/or process data stored remotely (e.g., in network storage resource 170).

Also in FIG. 1, memory subsystem 130 may comprise a system, device, or apparatus operable to retain and/or retrieve program instructions and/or data for a period of time (e.g., computer-readable media). Memory subsystem 130 may comprise random access memory (RAM), electrically erasable programmable read-only memory (EEPROM), a PCMCIA card, flash memory, magnetic storage, opto-magnetic storage, and/or a suitable selection and/or array of volatile or non-volatile memory that retains data after power to its associated information handling system, such as system 100, is powered down.

In information handling system 100, I/O subsystem 140 may comprise a system, device, or apparatus generally operable to receive and/or transmit data to/from/within information handling system 100. I/O subsystem 140 may represent, for example, a variety of communication interfaces, graphics interfaces, video interfaces, user input interfaces, and/or peripheral interfaces. In various embodiments, I/O subsystem 140 may be used to support various peripheral devices, such as a touch panel, a display adapter, a keyboard, an accelerometer, a touch pad, a gyroscope, an IR sensor, a microphone, a sensor, a camera, or another type of peripheral device.

Local storage resource 150 may comprise computer-readable media (e.g., hard disk drive, floppy disk drive, CD-ROM, and/or other types of rotating storage media, flash memory, EEPROM, and/or another type of solid state storage media) and may be generally operable to store instructions and/or data. Likewise, the network storage resource may comprise computer-readable media (e.g., hard disk drive, floppy disk drive, CD-ROM, and/or other types of rotating storage media, flash memory, EEPROM, and/or other types of solid state storage media) and may be generally operable to store instructions and/or data.

In FIG. 1, network interface 160 may be a suitable system, apparatus, or device operable to serve as an interface between information handling system 100 and a network 110. Network interface 160 may enable information handling system 100 to communicate over network 110 using a suitable transmission protocol and/or standard, including, but not limited to, transmission protocols and/or standards enumerated below with respect to the discussion of network 110. In some embodiments, network interface 160 may be communicatively coupled via network 110 to a network storage resource 170. Network 110 may be a public network or a private (e.g., corporate) network. The network may be implemented as, or may be a part of, a storage area network (SAN), a personal area network (PAN), a local area network (LAN), a metropolitan area network (MAN), a wide area network (WAN), a wireless local area network (WLAN), a virtual private network (VPN), an intranet, the Internet or another appropriate architecture or system that facilitates the communication of signals, data and/or messages (generally referred to as data). Network interface 160 may enable wired and/or wireless communications (e.g., NFC or Bluetooth) to and/or from information handling system 100.

In particular embodiments, network 110 may include one or more routers for routing data between client information handling systems 100 and server information handling systems 100. A device (e.g., a client information handling system 100 or a server information handling system 100) on network 110 may be addressed by a corresponding network address including, for example, an Internet protocol (IP) address, an Internet name, a Windows Internet name service (WINS) name, a domain name or other system name. In particular embodiments, network 110 may include one or more logical groupings of network devices such as, for example, one or more sites (e.g., customer sites) or subnets. As an example, a corporate network may include potentially thousands of offices or branches, each with its own subnet (or multiple subnets) having many devices. One or more client information handling systems 100 may communicate with one or more server information handling systems 100 via any suitable connection including, for example, a modem connection, a LAN connection including the Ethernet, or a broadband WAN connection including DSL, Cable, Ti, T3, Fiber Optics, Wi-Fi, or a mobile network connection including GSM, GPRS, 3G, or WiMax.

Network 110 may transmit data using a desired storage and/or communication protocol, including, but not limited to, Fibre Channel, Frame Relay, Asynchronous Transfer Mode (ATM), Internet protocol (IP), other packet-based protocol, small computer system interface (SCSI), Internet SCSI (iSCSI), Serial Attached SCSI (SAS) or another transport that operates with the SCSI protocol, advanced technology attachment (ATA), serial ATA (SATA), advanced technology attachment packet interface (ATAPI), serial storage architecture (SSA), integrated drive electronics (IDE), and/or any combination thereof. Network 110 and its various components may be implemented using hardware, software, or any combination thereof.

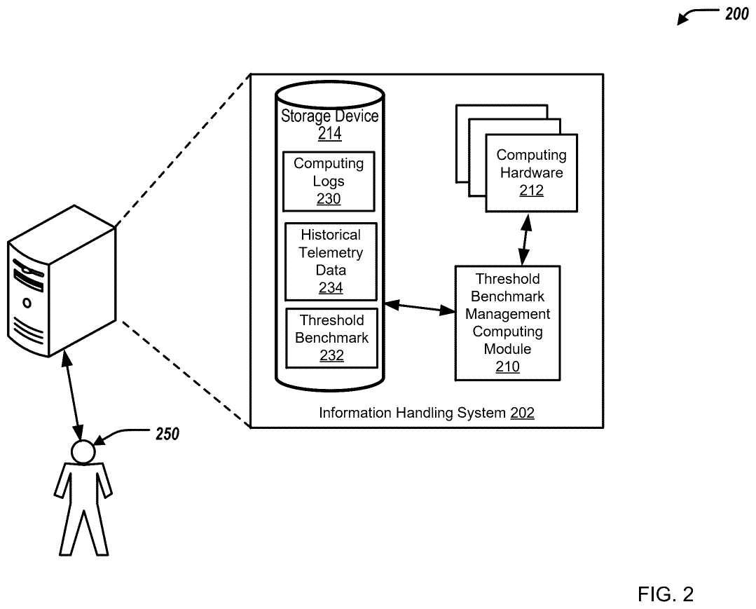

Turning to FIG. 2, FIG. 2 illustrates an environment 200 including an information handling system 202. The information handling system 202 can include a threshold benchmark management computing module 210, computing hardware 212, and a storage device 214. In some examples, the information handling system 202 is similar to, or includes, the information handling system 100 of FIG. 1.

The threshold benchmark management computing module 210 can be in communication with the computing hardware 212 and the storage device 214.

The computing hardware 212 can include memory, storage devices, video cards, audio cards, processors, and the like.

In short, the present invention discusses that to dynamically refresh threshold benchmarking after a service repair reset, the information handling system 202 detects the reset event by monitoring specific logs. Upon detection, the information handling system 202 reassesses and updates the threshold benchmarks. This involves collecting new data from the current state of the information handling system 202 and performance metrics, analyzing this data against historical records, and considering any changes in the configuration or environment of the information handling system 202. The analysis determines if existing thresholds are still appropriate or need adjustment to ensure accurate test pass/fail results.

Based on the analysis, the information handling system 202 updates the threshold benchmarks by setting new values, adjusting existing ones, or adding new benchmarks if necessary. These updated thresholds are then applied to maintain accurate and relevant benchmarks. The information handling system 202 continues to monitor its performance and make further adjustments as needed, ensuring the thresholds remain effective over time.

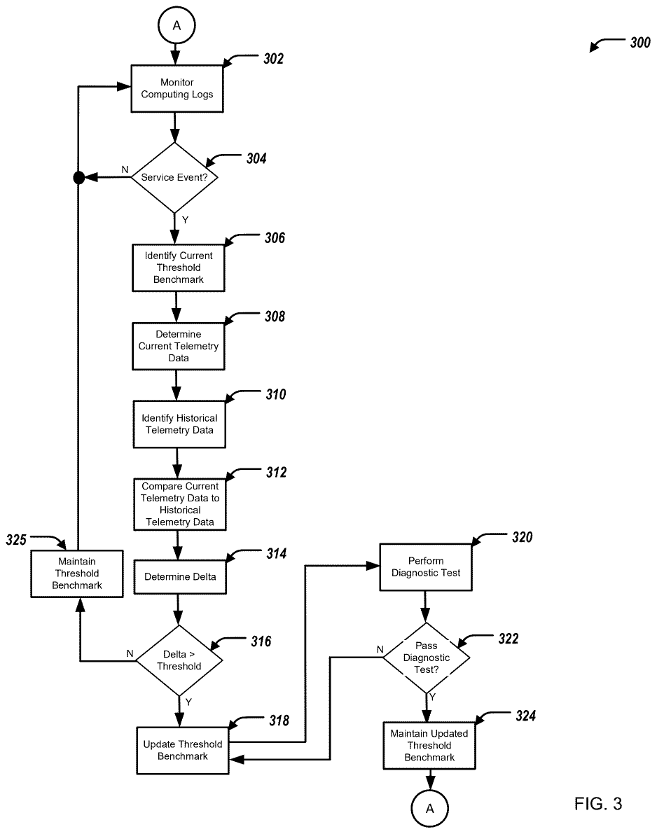

FIG. 3 illustrates a flowchart depicting selected elements of an embodiment of a method 300 for managing threshold benchmarking of computing hardware. The method 300 may be performed by the information handling system 100, the information handling system 202. and/or the threshold benchmark management computing module 210, and with reference to FIGS. 1-2. It is noted that certain operations described in method 300 may be optional or may be rearranged in different embodiments.

The threshold benchmark management computing module 210 monitors computing logs 230, at 302. The computing logs 230 can be stored at the storage device 214. In some examples, the computing logs 230 are stored at a boot partition of the storage device 214. In some examples, the computing logs 230 are stored in a hidden boot partition of the storage device 214. In some examples, the storage device 214 is a non-volatile memory express (NVME) storage device, and the computing logs 230 are stored in a hidden boot partition of the NVME drive.

The threshold benchmark management computing module 210 determines, based on monitoring the computing logs 230, whether a service event occurred at the information handling system 202, at 304. The service event can include a service reset of the information handling system 202. For example, the service event can include a repair, replacement, or the like of one or more of the computing hardware 212. In some examples, the service event can include resetting or restoring the information handling system 202 to factory, default, and/or golden settings. For example, the settings of the information handling system 202 can include threshold benchmarks. The threshold benchmarks can include base power limits, such as PL1, of a processor (computing hardware 212); maximum processor clock frequency; and/or a battery full charge capacity (FCC); however, the threshold benchmarks can relate to any benchmark of the computing hardware 212. The threshold benchmark can further include a touch screen sensitivity level or a storage wear level count (read/write cycles).

For example, a user 250 of the information handling system 202 can be experiencing issues with the information handling system 202 (e.g., performance related issues), and can have the information handling system 202 serviced. During such servicing, the service event can occur (e.g., a technician can perform the service event while repairing/replacing the computing hardware 212).

In some examples, the threshold benchmark management computing module 210 accesses the storage device 214 via an ACPI table through the BIOS of the information handling system 202.

In some examples, the threshold benchmark management computing module 210 determines that a service event occurred at the information handling system 202 (at 304), and in response, identifies a threshold benchmark 232 associated with the computing hardware 212, at 306. Specifically, the threshold benchmark management computing module 210 identifies the threshold benchmark 232 associated with the computing hardware 212 as stored by the storage device 214.

For example, during the service event, the threshold benchmark 232 for the PL1 value setting could be changed (override) from a custom value (e.g., 13 Watts) to a factory value (e.g., 15 Watts). For example, during the service event, the threshold benchmark 232 for maximum processor clock frequency can be changed from a custom value (e.g., 2.9 GHz) to a factor value (e.g., 3.0 GHz). For example, during the service event, the threshold benchmark 232 for battery FCC can be changed from a custom value (e.g., 90%) to a factory value (e.g., 100%).

The threshold benchmark management computing module 210 determines current telemetry data of the computing hardware 212, at 308. The telemetry data can represent properties, parameters, and the like, of the computing hardware 212. For example, the telemetry data can include processor parameters, temperature of the computing hardware 212, processing parameters of the computing hardware 212, data access parameters of memory, battery information, battery state, network performance parameters and speed, BIOS version, OS version, and the like.

In some examples, the telemetry data can include device wear level (SPI, storage, and the like); CPU usage (percentage of CPU capacity being used by the information handling system 202); memory usage (amount of memory being utilized); disk I/O (read and write operations on the disk); network latency (time it takes for data to travel from one point to another in a network); temperature (temperature of various components like CPU, GPU, motherboard, and the like); fan speed (speed of cooling fans); power consumption (amount of power being used by the information handling system 202); error logs (errors or warnings generated by the information handling system 202); boot time (time taken for the information handling system 202 to boot up); and application performance (performance of specific applications running on the information handling system 202).

The threshold benchmark management computing module 210 identifies historical telemetry data 234 of the computing hardware 212, at 310. The historical telemetry data 234 can be stored by the storage device 214. The historical telemetry data 234 of the computing hardware 212 can indicate the telemetry data of the computing hardware 212 at one or more times before the service event of the information handling system 202. The historical telemetry data 234 of the computing hardware 212 can indicate the telemetry data of the computing hardware 212 immediately before the service event, or proximate to the service event (e.g., 1 minute before, 1 hour before, 1 day before).

The threshold benchmark management computing module 210 can compare the current telemetry data of the computing hardware 212 to the historical telemetry data 234 of the computing hardware 212, at 312. For example, when the telemetry data relates to a temperature of a processor (computing hardware 212), the threshold benchmark management computing module 210 can compare the current temperature of the processor (from the current telemetry data) to the previous temperature of the processor (from the historical telemetry data).

The threshold benchmark management computing module 210 can determine, based on the comparing, a delta between the current telemetry data of the computing hardware 212 and the historical telemetry data 234 of the computing hardware 212, at 314. For example, when the telemetry data relates to a temperature of a processor (computing hardware 212), the threshold benchmark management computing module 210 determines a delta between the current temperature of the processor and the historical temperature of the processor. For example, when the telemetry data relates to usage of a processor (computing hardware 212), the threshold benchmark management computing module 210 determines a delta between the current usage of the processor and the historical usage of the processor. For example, when the telemetry data relates to a temperature of a battery (computing hardware 212), the threshold benchmark management computing module 210 determines a delta between the current temperature of the battery and the historical temperature of the battery.

The threshold benchmark management computing module 210 can compare the delta (between the current telemetry data and the historical telemetry data) to a threshold, at 316. In some examples, the threshold is zero, or approximately zero. In some examples, the threshold is based on the computing hardware 212, and/or the telemetry data.

In some cases, the threshold benchmark management computing module 210 determines that the delta (between the current telemetry data and the historical telemetry data) is greater than the threshold (at 316), and in response, updates the threshold benchmark 232 for the computing hardware 212, at 318. In short, the threshold benchmark management computing module 210 can determine if the (existing/current) threshold benchmark 232 is appropriate for the information handling system 202 based on the delta, and updates the threshold benchmark 232 accordingly. In some examples, the threshold benchmark management computing module 210 could update the value of the threshold benchmark 232, adjust the value of the threshold benchmark 232, or add a new threshold benchmark 232 for the computing hardware 212. In some examples, the threshold benchmark management computing module 210 updates the threshold benchmark 232 based on a previously stored value. In some examples, the threshold benchmark management computing module 210 updates the threshold benchmark 232 based on a previously stored value associated with a timestamp immediately before the service event, or proximate to the service event (e.g., 1 minute before, 1 hour before, 1 day before).

For example, based on the delta (between the current processor temperature telemetry data and the historical processor temperature telemetry data) being greater than the threshold (e.g., zero), the threshold benchmark management computing module 210 updates the threshold benchmark 232 for the PL1 value of the processor from the factory setting (e.g., 15 Watts) to the custom value (e.g., 13 Watts). For example, based on the delta (between the current processor usage telemetry data and the historical processor usage telemetry data) being greater than the threshold (e.g., zero), the threshold benchmark management computing module 210 updates the threshold benchmark 232 for the maximum processor clock frequency value of the processor from the factory setting (e.g., 3.0 GHz) to the custom value (e.g., 2.9 GHz). For example, based on the delta (between the current battery temperature telemetry data and the historical battery temperature telemetry data) being greater than the threshold (e.g., zero), the threshold benchmark management computing module 210 updates the threshold benchmark 232 for the battery FCC value of the battery from the factory setting (e.g., 100%) to the custom value (e.g., 90%).

The threshold benchmark management computing module 210 performs, at the computing hardware 212, a diagnostic test based on the updated threshold benchmark 232, at 320. That is, the threshold benchmark management computing module 210 performs, at the computing hardware 212, the diagnostic test per the previous threshold benchmark 232 (and not the factory threshold benchmark 232).

For example, the diagnostic test can be a diagnostic test of the processor based on the updated threshold benchmark 232. For example, the diagnostic test can be a diagnostic test of the processor based on the updated threshold benchmark 232 for the PL1 value of the processor of 13 Watts. For example, the diagnostic test can be a thermal diagnostic test of the processor based on the updated threshold benchmark 232 for the PL1 value of the processor.

For example, the diagnostic test can be a diagnostic test of the processor based on the updated threshold benchmark 232. For example, the diagnostic test can be a diagnostic test of the processor based on the updated threshold benchmark 232 for the maximum processor clock frequency of the processor of 2.9 GHz. For example, the diagnostic test can be a diagnostic test of the processor based on the updated threshold benchmark 232 for the maximum processor clock frequency of the processor.

For example, the diagnostic test can be a diagnostic test of the battery based on the updated threshold benchmark 232. For example, the diagnostic test can be a diagnostic test of the battery based on the updated threshold benchmark 232 for the battery FCC of the battery of 90%. For example, the diagnostic test can be a diagnostic test of the battery based on the updated threshold benchmark 232 for the battery FCC of the battery.

The threshold benchmark management computing module 210 determines whether the computing hardware 212 passed the diagnostic test, at 322. That is, the threshold benchmark management computing module 210 determines whether the computing hardware 212 passed the diagnostic test based on the updated threshold benchmark 232.

For example, when the computing hardware 212 is a processor, the threshold benchmark management computing module 210 determines whether the processor passed a thermal diagnostic test based on the updated threshold benchmark for the PL1 value of the processor. For example, when the computing hardware 212 is a processor, the threshold benchmark management computing module 210 determines whether the processor passed a thermal diagnostic test based on the updated threshold benchmark for the PL1 value of the processor of 13 Watts.

For example, when the computing hardware 212 is a processor, the threshold benchmark management computing module 210 determines whether the processor passed a diagnostic test based on the updated threshold benchmark for the maximum processor clock frequency value of the processor. For example, when the computing hardware 212 is a processor, the threshold benchmark management computing module 210 determines whether the processor passed a diagnostic test based on the updated threshold benchmark for the maximum processor clock frequency value of the processor of 2.9 GHz.

For example, when the computing hardware 212 is a battery, the threshold benchmark management computing module 210 determines whether the battery passed a thermal diagnostic test based on the updated threshold benchmark for the battery FCC value of the battery. For example, when the computing hardware 212 is a battery, the threshold benchmark management computing module 210 determines whether the battery passed a thermal diagnostic test based on the updated threshold benchmark for the battery FCC value of the battery of 90%.

In some examples, the threshold benchmark management computing module 210 determines that the computing hardware 212 passed the diagnostic test (at 322), and in response, maintains the updated threshold benchmark 232, at 324. That is, the threshold benchmark management computing module 210 stores the updated threshold benchmark 232 at the storage device 214.

For example, when the threshold benchmark is the PL1 value of the processor, the threshold benchmark management computing module 210 maintains the updated threshold benchmark 232 of 13 Watts. For example, when the threshold benchmark is the maximum processor clock frequency of the processor, the threshold benchmark management computing module 210 maintains the updated threshold benchmark 232 of 2.9 GHz. For example, when the threshold benchmark is the battery FCC of the battery, the threshold benchmark management computing module 210 maintains the updated threshold benchmark 232 of 90%.

In some cases, the threshold benchmark management computing module 210 determines that the delta (between the current telemetry data and the historical telemetry data) is less than (or equal to) the threshold (at 316), and in response, maintains the threshold bookmark, at 325. That is, the threshold benchmark management computing module 210 determines that the current telemetry data (of the computing hardware 212) is substantially the same as the historical telemetry data 234 (of the computing hardware 212), and in response, maintains the threshold benchmark 232. That is, the threshold benchmark management computing module 210 maintains the threshold benchmark 232 at the storage device 214. The method returns to step 302.

For example, based on the delta (between the current processor temperature telemetry data and the historical processor temperature telemetry data) being less than (or equal to) the threshold (e.g., zero) (e.g., substantially equal to zero), the threshold benchmark management computing module 210 maintains the threshold benchmark 232 for the PL1 value of the processor of the factory setting (e.g., 15 Watts).

For example, based on the delta (between the current processor usage telemetry data and the historical processor usage telemetry data) being less than (or equal to) the threshold (e.g., zero) (e.g., substantially equal to zero), the threshold benchmark management computing module 210 maintains the threshold benchmark 232 for the maximum processor clock frequency of the processor of the factory setting (e.g., 3.0 GHz).

For example, based on the delta (between the current battery temperature telemetry data and the historical battery temperature telemetry data) being less than (or equal to) the threshold (e.g., zero) (e.g., substantially equal to zero), the threshold benchmark management computing module 210 maintains the threshold benchmark 232 for the battery FCC of the battery of the factory setting (e.g., 100%).

In some cases, the threshold benchmark management computing module 210 determines that the computing hardware 212 failed the diagnostic test (at 322), and in response, further updates the updated threshold benchmark 232 for the computing hardware 212, at 318. In short, the threshold benchmark management computing module 210 can determine if the updated threshold benchmark 232 is appropriate for the information handling system 202 based on the delta, and updates the updated threshold benchmark 232 accordingly.

For example, based on the delta (between the current processor temperature telemetry data and the historical processor temperature telemetry data) being greater than the threshold (e.g., zero), the threshold benchmark management computing module 210 updates the updated threshold benchmark 232 for the PL1 value of the processor from the custom setting (e.g., 13 Watts) to a further custom value (e.g., 12 Watts).

The threshold benchmark management computing module 210 performs, at the computing hardware 212, a further diagnostic test based on the further updated threshold benchmark 232, at 320. That is, the threshold benchmark management computing module 210 performs, at the computing hardware 212, the further diagnostic test per the further updated threshold benchmark 232. For example, the diagnostic test can be a diagnostic test of the processor based on the further updated threshold benchmark 232. For example, the further diagnostic test can be a diagnostic test of the processor based on the further updated threshold benchmark 232 for the PL1 value of the processor of 12 Watts. For example, the further diagnostic test can be a thermal diagnostic test of the processor based on the further updated threshold benchmark 232 for the PL1 value of the processor.

The threshold benchmark management computing module 210 determines whether the computing hardware 212 passed the further diagnostic test, at 322. That is, the threshold benchmark management computing module 210 determines whether the computing hardware 212 passed the further diagnostic test based on the further updated threshold benchmark 232. For example, when the computing hardware 212 is a processor, the threshold benchmark management computing module 210 determines whether the processor passed the thermal diagnostic test based on the further updated threshold benchmark for the PL1 value of the processor. For example, when the computing hardware 212 is a processor, the threshold benchmark management computing module 210 determines whether the processor based the further thermal diagnostic test passed the further updated threshold benchmark for the PL1 value of the processor of 12 Watts.

In some examples, the threshold benchmark management computing module 210 determines that the computing hardware 212 passed the further diagnostic test (at 322), and in response, maintains the further updated threshold benchmark 232, at 324. That is, the threshold benchmark management computing module 210 stores the further updated threshold benchmark 232 at the storage device 214. For example, when the threshold benchmark is the PL1 value of the processor, the threshold benchmark management computing module 210 maintains the further updated threshold benchmark 232 of 12 Watts.

In some implementations, the threshold benchmark management computing module 210 can continue to monitor the performance of the computing hardware 212 and further adjust the threshold benchmark 232 as needed.

In some examples, the threshold benchmark management computing module 210 determines that a service event did not or has not occurred at the information handling system 202 (at 304), and in response, returns to step 302.

The threshold benchmark management computing module 210 performs the management of the threshold benchmarking of the computing hardware 212, including at least monitoring the computing logs 230, determining that a service event occurred, updating the threshold benchmark, performing the diagnostic test, and/or maintaining the updated threshold benchmark independent of user action by the user 250 of the information handling system 202. That is, the threshold benchmark management computing module 210 performs the management of the threshold benchmarking of the computing hardware 212 at the information handling system 202 automatically and without user interaction/input. The threshold benchmark management computing module 210 can perform the management of the threshold benchmarking of the computing hardware 212 to provide operability of the computing features of the hardware device 212 by improving performance capabilities of the information handling system 202 (such as the computing device 212). That is, performing the management of the threshold benchmarking of the computing hardware 212 by the threshold benchmark management computing module 210 improves the performance capabilities of the information handling system 202 (the hardware devices 212) such that the functionality and the operability of the computing features of the hardware devices 212 is improved. In some examples, the threshold benchmark management computing module 210 can perform the management of the threshold benchmarking of the computing hardware 212 to improve the performance capabilities of the information handling system 202 and the hardware devices 212 without user action/input by the user 250 (independent of user action/input by the user 250).

In some examples, after the threshold benchmark 232 has been updated, the threshold benchmark management computing module 210 can perform a remediation action at the computing hardware 212.

In some examples, the threshold benchmark management computing module 210, in response to updating the threshold benchmark 232, can perform the remediation action of uninstalling a driver associated with the computing hardware 212 without input/interaction by the user 250. That is, the threshold benchmark management computing module 210 can uninstall, or facilitate uninstallation of, the driver at the computing hardware 212 automatically in response to updating the threshold benchmark 232.

In some examples, the threshold benchmark management computing module 210, in response to updating the threshold benchmark 232, can perform the remediation action of updating a driver associated with the computing hardware 212 without input/interaction by the user 250. That is, the threshold benchmark management computing module 210 can update, or facilitate updating of, the driver at the computing hardware 212 automatically in response to updating the threshold benchmark 232.

In some examples, the threshold benchmark management computing module 210, in response to updating the threshold benchmark 232, can perform the remediation action of disabling a driver associated with the computing hardware 212 without input/interaction by the user 250. That is, the threshold benchmark management computing module 210 can disable, or facilitate disabling of, the driver at the computing hardware 212 automatically in response to updating the threshold benchmark 232.

In some examples, the threshold benchmark management computing module 210, in response to updating the threshold benchmark 232, can perform the remediation action of installing a new driver associated with the computing hardware 212 without input/interaction by the user 250. That is, the threshold benchmark management computing module 210 can install, or facilitate installing of, the new driver at the computing hardware 212 automatically in response to updating the threshold benchmark 232.

In some examples, the threshold benchmark management computing module 210, in response to updating the threshold benchmark 232, can perform the remediation action of updating firmware associated with the computing hardware 212 without input/interaction by the user 250. That is, the threshold benchmark management computing module 210 can update, or facilitate updating of, the firmware at the computing hardware 212 automatically in response to updating the threshold benchmark 232.

In some examples, the threshold benchmark management computing module 210, in response to updating the threshold benchmark 232, can perform the remediation action of updating a configuration associated with the computing hardware 212 without input/interaction by the user 250. That is, the threshold benchmark management computing module 210 can update, or facilitate updating of, the configuration at the computing hardware 212 automatically in response to updating the threshold benchmark 232.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, features, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

What is claimed is:

1. A computer-implemented method of managing threshold benchmarking of computing hardware of an information handling system, including:
monitoring computing logs of the information handling system;
determining, based on monitoring the computing logs, whether a service event occurred at the information handling system;
determining that a service event occurred at the information handling system, and in response:
identifying a threshold benchmark associated with a computing hardware of the information handling system;
determining current telemetry data of the computing hardware;
identifying historical telemetry data of the computing hardware;
comparing the current telemetry data to the historical telemetry data;
determining, based on the comparing, a delta between the current telemetry data and the historical telemetry data, and in response:
updating, based on the delta, the threshold benchmark for the computing hardware;
performing, at the computing hardware, a diagnostic test based on the updated threshold benchmark;
determining whether the computing hardware passed the diagnostic test; and
determining that the computing hardware passed the diagnostic test, and in response:
maintaining the updated threshold benchmark.

2. The computer-implemented method of claim 1, wherein the computing logs are stored in a boot partition of a storage drive.

3. The computer-implemented method of claim 1, wherein the threshold benchmark is a base power limit (PL1).

4. The computer-implemented method of claim 1, wherein the threshold benchmark is a maximum processor clock frequency.

5. The computer-implemented method of claim 1, wherein the threshold benchmark is a battery full charge capacity (FCC).

6. The computer-implemented method of claim 1, further including:
determining, based on the comparing, that the current telemetry data is substantially the same as the historical telemetry data, and in response, maintaining the threshold benchmark.

7. The computer-implemented method of claim 1, further including:
determining that the computing hardware failed the diagnostic test, and in response:
further updating the updated threshold benchmark for the computing hardware;
performing, at the computing hardware, a further diagnostic test based on the further updated threshold benchmark;
determining whether the computing hardware passed the further diagnostic test; and
determining that the computing hardware passed the further diagnostic test, and in response:
maintaining the further updated threshold benchmark.

8. An information handling system comprising a processor having access to memory media storing instructions executable by the processor to perform operations, comprising:
monitoring computing logs of the information handling system;
determining, based on monitoring the computing logs, whether a service event occurred at the information handling system;
determining that a service event occurred at the information handling system, and in response:
identifying a threshold benchmark associated with a computing hardware of the information handling system;
determining current telemetry data of the computing hardware;
identifying historical telemetry data of the computing hardware;
comparing the current telemetry data to the historical telemetry data;
determining, based on the comparing, a delta between the current telemetry data and the historical telemetry data, and in response:
updating, based on the delta, the threshold benchmark for the computing hardware;
performing, at the computing hardware, a diagnostic test based on the updated threshold benchmark;
determining whether the computing hardware passed the diagnostic test; and
determining that the computing hardware passed the diagnostic test, and in response:
maintaining the updated threshold benchmark.

9. The information handling system of claim 8, wherein the computing logs are stored in a boot partition of a storage drive.

10. The information handling system of claim 8, wherein the threshold benchmark is a base power limit (PL1).

11. The information handling system of claim 8, wherein the threshold benchmark is a maximum processor clock frequency.

12. The information handling system of claim 8, wherein the threshold benchmark is a battery full charge capacity (FCC).

13. The information handling system of claim 8, the operations further including:
determining, based on the comparing, that the current telemetry data is substantially the same as the historical telemetry data, and in response, maintaining the threshold benchmark.

14. The information handling system of claim 8, the operations further including:
determining that the computing hardware failed the diagnostic test, and in response:
further updating the updated threshold benchmark for the computing hardware;
performing, at the computing hardware, a further diagnostic test based on the further updated threshold benchmark;
determining whether the computing hardware passed the further diagnostic test; and
determining that the computing hardware passed the further diagnostic test, and in response:
maintaining the further updated threshold benchmark.

15. A non-transitory computer-readable medium storing software comprising instructions executable by one or more computers which, upon such execution, cause the one or more computers to perform operations comprising:
monitoring computing logs of the information handling system;
determining, based on monitoring the computing logs, whether a service event occurred at the information handling system;
determining that a service event occurred at the information handling system, and in response:
identifying a threshold benchmark associated with a computing hardware of the information handling system;
determining current telemetry data of the computing hardware;
identifying historical telemetry data of the computing hardware;
comparing the current telemetry data to the historical telemetry data;
determining, based on the comparing, a delta between the current telemetry data and the historical telemetry data, and in response:
updating, based on the delta, the threshold benchmark for the computing hardware;
performing, at the computing hardware, a diagnostic test based on the updated threshold benchmark;
determining whether the computing hardware passed the diagnostic test; and
determining that the computing hardware passed the diagnostic test, and in response:
maintaining the updated threshold benchmark.

16. The non-transitory computer-readable medium of claim 15, wherein the computing logs are stored in a boot partition of a storage drive.

17. The non-transitory computer-readable medium of claim 15, wherein the threshold benchmark is a base power limit (PL1).

18. The non-transitory computer-readable medium of claim 15, wherein the threshold benchmark is a maximum processor clock frequency.

19. The non-transitory computer-readable medium of claim 15, wherein the threshold benchmark is a battery full charge capacity (FCC).

20. The non-transitory computer-readable medium of claim 15, the operations further including:
determining, based on the comparing, that the current telemetry data is substantially the same as the historical telemetry data, and in response, maintaining the threshold benchmark.
